(19) United States
(12) Patent Application Publication
(10) Pub. No.: US 2004/0090133 A1
(43) Pub. Date: May 13, 2004

(54) Alternator assembly

(76) Inventors: Steven John Yockey, Ypsilanti, MI (US); Richard Kenneth Harris, Pinckney, MI (US); David William Linden, Ann Arbor, MI (US)

Correspondence Address: VISTEON 29074, BRINKS HOFER GILSON & LIONE, P.O. BOX 10395, CHICAGO, IL, 60611, US

(21) Appl. No.: 10/293,676

(22) Filed: Nov. 13, 2002

(51) Int. Cl. H02K 5/00; H02K 1/22

(52) U.S. Cl. 310/89; 310/263

(57) ABSTRACT

An alternator assembly powered by a pulley is made up of an outer housing that contains the stator and rotor assemblies, an inner housing and a rear cover which is retained by a fastening member that secures the inner housing and rear cover within the outer housing.

### FIELD OF THE INVENTION

The present invention relates generally to an alternator, more particularly, the present invention is related to a housing for a motor vehicle alternator.

### DESCRIPTION OF PRIOR ART

Alternators are used in many modern-day industries to convert mechanical power to electrical power within an engine. In the motor vehicle industry, in particular, alternators have become a staple item. Alternators are now used in virtually every automobile produced. This translates into a large overall production cost for automotive manufacturers and automotive parts manufacturers.

Furthermore, the technology boom of the last couple decades has had a significant impact on the automotive industry. As customers demand more gadgets and feedback on their vehicle performance, automobiles now contain a dramatically increased number of electronic devices. This trend has increased the electrical output demanded of the alternators used within the automobiles and has increased their size. With an increased number of components to be packaged and a larger alternator required to power them, the always tight packaging space in a vehicle has become even more of an issue.

The housing unit is a large component of an alternator unit. Modern alternators generally include a housing comprised of at least two housing pieces. One function of this configuration is to contain the inner components of the alternator. The most common way of attaching the two housing pieces is by using a plurality of thru-bolts and nuts. In this configuration, the thru-bolts are inserted through cavities disposed in the two housing pieces and then threaded into cavities disposed in the other housing, thereby creating a rigid outer housing that retains and protects the internal components of the alternator.

As a result of the well-known method and apparatus discussed above, the cost-efficiency as well as the space-efficiency of contemporary alternators is not optimized. More specifically, the use of thru bolts adds unnecessary weight to the assembly and consumes excessive space within and around the assembly. Furthermore, the space consumed by the thru-bolt and nut combination frequently interferes with the placement of other engine components.

Therefore, there is a need in the automotive industry, as well as in other industries, for a smaller and improved housing assembly for retaining and protecting the internal components of an alternator.

### BRIEF SUMMARY OF THE INVENTION

In accordance with the present invention, a housing means is provided to retain the internal components of an alternator without the use of thru-bolts to hold the front and rear housing together. An inner and outer housing is used where an internal thread is cut into the top of the outer alternator housing. The internal thread is capable of receiving an externally threaded packing nut. When the packing nut is tightened the inner housing is seated on a machined surface on the outer housing. The packing nut is tightened with a device such as a spanner wrench.

The packing nut and housing combination replaces the commonly used thru-bolts, which require a boss on the exterior of the alternator and increase the packaging space in the vehicle required for the alternator.

The packing nut retention of the can may be improved by a number of methods. An anaerobic locking compound can be added to the external threads on the packing nut prior to installation to improve retention. An mechanical crimp of the exterior of the outer housing can be made locking the outer housing to the fastener also to improve retention.

Additional benefits and advantages of the present invention will become apparent to those skilled in the art to which the present invention relates from the subsequent description of the preferred embodiments and the appended claims, taken in conjunction with the accompanying drawings.

### BRIEF DESCRIPTION OF THE DRAWINGS

FIG. 1 is a side view of a section through the alternator assembly of the present invention;

FIG. 2 is a side view of a section through a prior art design of an alternator assembly; and

FIG. 3 is a side view of an enlarged section through the alternator assembly of the present invention.

### DETAILED DESCRIPTION

The foregoing discussion discloses and describes the preferred embodiment of the invention. One skilled in the art will readily recognize from such discussion, and from the accompanying drawings and claims, that changes and modifications can be made to the invention without departing from the true spirit and fair scope of the invention as defined in the following claims. The invention has been described in an illustrative manner, and it is to be understood that the terminology which has been used is intended to be in the nature of words of description rather than of limitation.

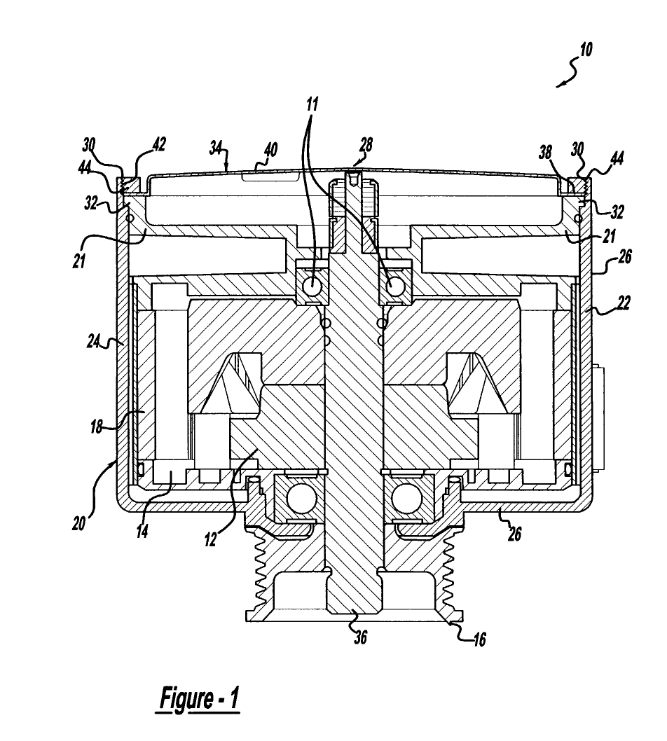

Referring now to FIG. 1, an alternator assembly 10 is shown. The alternator assembly 10 includes a rotor 12 that is attached to a pulley 16 by a shaft 36 rotatably mounted within the assembly 10 on bearings 11. As the vehicle engine runs a belt (not shown) coupled to the pulley 16 causes rotation of the pulley 16 and therefore the rotor 12. Rotation of the rotor 12 producing a magnetic field in the rotor 12. The rotor 12 is surrounded by a stator 14 that includes a set of coils and an iron core 18. The stator 14 is stationary in the alternator assembly 10. As the magnetic field from the rotor 12 sweeps through the stator 14, it produces electrical current for use in the vehicle. Enclosing the coils at the stator 14 by an inner housing or stator cover 18. The stator core 18 is in turn enclosed by and is fixed, possibly by a press fit, to a rear inner housing 21. Rear inner housing 21 fits inside an outer housing 20.

The outer housing 20 is generally cylindrical in shape and is composed of sides 22 and 24, a closed end 26 and an open end 28. The closed end 26 is open near its middle and shaft 36 extends therethrough locating the pulley 16 outside the housing 20. On the open end 28 of the outer housing 20 are internal threads 30 and inboard of the internal threads 30 is a machined shoulder 32. The shoulder 32 operates as a seat where flange 33 of the rear inner housing 21 is received. The rear cover 34 is a generally fiat component with a flat surface 40 with stepped flange 38 that is bent downward then extend outward from the flat surface 40. The stepped flange 38 sit atop the flange 33 and the rear inner housing 21. The rear cover 34 encloses the open end 28 of the outer housing 20.

The rotor 12 and stator 14 and all other internal components of the alternator assembly 10 are thus enclosed within the outer housing 20.

Retaining rear cover 34 and inner housing 21 within outer housing 20 is a packing nut 42. The packing nut 42 is generally a ring shape and fits atop the stepped flange 38 of the rear cover 34. The packing nut 42 is provided with external threads 44 that matingly engage the internal threads 30 of the outer housing 20.

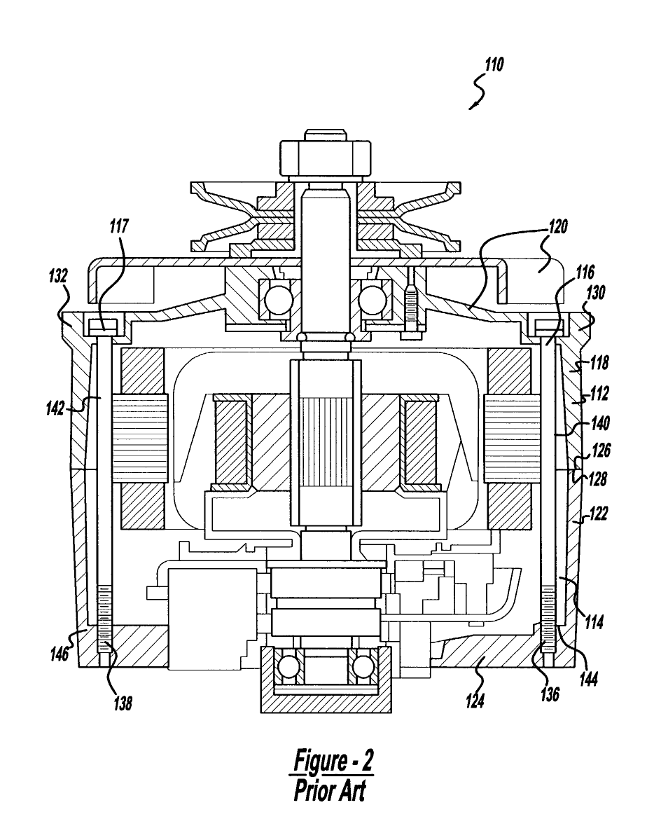

Now referring to FIG. 2, the alternator assembly 110 of the prior art is shown. The internal components of the alternator assembly 110 are surrounded by an outboard housing 112 and an inboard housing 114. Outboard housing 112 is generally cylindrical in shape and consists of a closed end 120, and an open end 126. Inboard housing 114 is also generally cylindrical in shape and consists of a closed end 124 and open end 128. Outboard housing 112 meets inboard housing 114 at open end 126 and open end 128, respectively.

Housing 112 also contains bosses 130 and 132 on the outer edges of top 120. Thru bolts 116 and 117 fit into bosses 130 and 132. Thru bolts 116 and 117 contain threaded portions 136 and 138 at their ends, respectively. Thru bolts 116 and 117 fit through top housing 112 at thru holes 140 and 142 threaded end portions 136 and 138 of thru bolts 116 and 117, respectively, engage threaded bores 144 and 146 of inboard housing 114. The upper housing 112 and lower housing 114 are thus fastened together, thus securing the internal components of the alternator assembly 10.

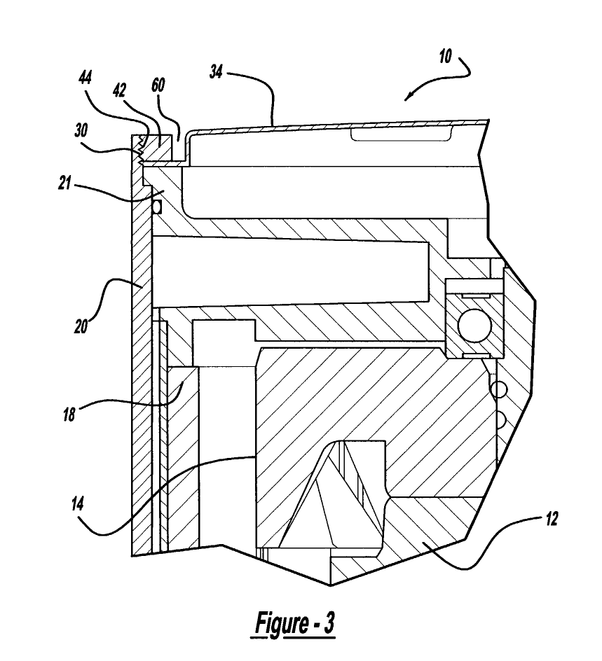

Referring to FIG. 3, the alternator assembly 10 is shown after the installation of the packing nut 42 in a close-up sectional view. The stator core 18 is positioned within rear inner housing 21. The rear cover 34 sits atop the rear inner housing 21. The packing nut 42 secures the rear cover 34 as well as the rear inner housing 21 and the stator assembly 14 to the outer housing 20.

The packing nut 42 preferably includes multiple spanner slots 60 such that a spanner wrench may engage the spanner slots 60 to rotate or tighten packing nut 42. As a result of being tightened, external threads 44 are in contact with the internal threads 30 of outer housing 20 and rotor 12 and stator 14 are secured within the outer housing 20, rear inner housing 21 and rear cover 34.

A retaining compound may be applied between external threads 44 and internal threads 30. The retaining compound is preferably a liquid that is applied to one or both of external threads 44 and internal threads 30 before packing nut 42 is tightened. The retaining compound functions to prevent movement of packing nut 42 and outer housing 20 relative to one another. Multiple suitable retaining compounds will be known to persons of ordinary skill in the art.

As an alternative to the retaining compound, a mechanical stake may be used to secure packing nut 42 and outer housing 20. For example, once packing nut 34 has been tightened, external threads 44 and internal threads 30 may be deformed in corresponding locations to prevent relative rotation between packing nut 42 and outer housing 20. Alternatively, other suitable methods of forming a mechanical stake known to persons of ordinary skill in the art may be used.

While the above description constitutes the preferred embodiments of the present invention, it will be appreciated that the invention is susceptible to modification, variation and change without departing from the proper scope and fair meaning of the accompanying claims.

1. An alternator assembly comprising:
an outer housing of a hollow generally cylindrical shape with a generally closed first end and a generally open second end, wherein said stator cover rounded sides fit within the outer housing and the alternator pulley fits through said outer housing first end;
a rotor located within said outer housing and mounted to a shaft, said shaft being rotatably mounted within said outer housing and having an distal end protruding through said generally closed first end of said outer housing;
a pulley secured to said distal end of said shaft;
a stator located generally about said rotor and within said outer housing;
a rear cover adjacent said generally open end of said outer housing; and
a retaining member engaging said generally open end of said outer housing and securing said rear cover to said outer housing.

2. The alternator assembly of claim 1 wherein said generally open end of said outer housing is provided with internal threads.

3. The alternator assembly of claim 2 wherein said retainer is provided with external threads, said external threads matingly engaging said internal threads.

4. The alternator assembly of claim 3 further comprising a retaining compound located between said outer threads of said retaining member and said external threads of said outer housing.

5. The alternator assembly of claim 1 further comprising a retaining compound located between said retaining member and said outer housing.

6. The alternator assembly of claim 1 wherein engaging means are provided on said retainer to facilitate engaging said retainer with said outer housing.

7. The alternator assembly of claim 6 wherein said engaging means are slots formed in said retainer.

8. The alternator assembly of claim 1 wherein said retainer is staked to said outer housing.

9. The alternator assembly of claim 1 wherein said retainer is a nut.

10. An alternator assembly comprising:
an outer housing of a hollow generally cylindrical shape with a generally closed first end and a generally open second end, wherein said stator cover rounded sides fit within the outer housing and the alternator pulley fits through said outer housing first end;
a rotor located within said outer housing and mounted to a shaft, said shaft being rotatably mounted within said outer housing and having an distal end protruding through said generally closed first end of said outer housing;
a pulley secured to said distal end of said shaft;
a stator located generally about said rotor and within said outer housing;
a rear cover adjacent said generally open end of said outer housing; and
retainer means for engaging said generally open end of said outer housing and retaining said rear cover to said outer housing.

11. The alternator assembly of claim 10 wherein said generally open end of said outer housing is provided with internal threads.

12. The alternator assembly of claim 11 wherein said retainer means is provided with external threads, said external threads matingly engaging said internal threads.

13. The alternator assembly of claim 12 further comprising a retaining compound located between said outer threads of said retaining means and said external threads of said outer housing.

14. The alternator assembly of claim 10 further comprising a retaining compound located between said retaining means and said outer housing.

15. The alternator assembly of claim 10 wherein an engaging means is provided on said retaining means to facilitate engaging said retaining means with said outer housing.

16. The alternator assembly of claim 15 wherein said engaging means are slots formed in said retaining means.

17. The alternator assembly of claim 10 wherein said retaining means is staked to said outer housing.

18. The alternator assembly of claim 1 wherein said retaining means is a nut.

19. A method for assembling an alternator comprising the steps of:
providing a rotor;
locating said rotor within a stator;
surrounding the rotor and stator with a housing;
placing a cover adjacent to the housing;
securing the cover to the housing by a threaded engagment.

20. The method of claim 19 wherein said securing step is performed by engaging an externally threaded nut to an internally threaded portion of the housing.
